(19) United States
(12) Patent Application Publication
(10) Pub. No.: US 2025/0116361 A1
(43) Pub. Date: Apr. 10, 2025

(54) Quick Pipe Connector

(71) Applicant: TAIZHOU AILUN VALVE CO., LTD, Yuhuan City (CN)

(72) Inventors: Hewen LIANG, Yuhuan (CN); Shicheng LIANG, Yuhuan (CN); Chienyu LIN, New Taipei City (TW)

(21) Appl. No.: 18/986,642

(22) Filed: Dec. 18, 2024

Related U.S. Application Data
(63) Continuation-in-part of application No. 18/656,517, filed on May 6, 2024.
Application No. 18/656,517 is a continuation-in-part of application No. 18/410,977, filed on Jan. 11, 2024.

(30) Foreign Application Priority Data
Jun. 2, 2023 (CN) 202321397279.2
Jun. 21, 2024 (CN) 2024214401213

(51) Int. Cl. F16L 37/091

(52) U.S. Cl. CPC F16L 37/0915

(57) ABSTRACT

A quick pipe connector includes a connector body, an inner sealing ring, an outer sealing ring, a biasing ring sandwiched between the inner sealing ring and the outer sealing ring, a securing ring attached to a connecting portion of the connector body, an engaging member arranged to bias against the securing ring and includes a plurality of catching claws, and a coupling sleeve. The coupling sleeve includes a main sleeve member having a through hole, and an extension sleeve extending from the main sleeve member to engage with the connecting portion of the connector body. When the pipe is inserted in the connector body, the inner sealing ring, the outer sealing ring, the biasing ring, the securing ring and the engaging member are securely biased and retained between the connector body and the main sleeve member.

### Cross References of Related Applications

This is a Continuation-In-Part (CIP) of a non-provisional application having an application Ser. No. 18/656,517, and a filing date of May 6, 2024, which is a Continuation-In-Part (CIP) of a non-provisional application having an application Ser. No. 18/410,977, and a filing date of Jan. 11, 2024, which claimed the priority of a Chinese patent application having an application number of 202321397279.2 and a filing date of Jun. 2, 2023. The disclosure of these applications, including any amendment thereto, are hereby incorporated by reference in its entirely.

This is also a non-provisional application which claims priority of a Chinese patent application having an application number of 2024214401213 and a filing date of Jun. 21, 2024. The disclosure of this application is hereby incorporated by reference in its entirely.

### BACKGROUND OF THE PRESENT INVENTION

### Field of Invention

The present invention relates to connector, and more particularly to a quick pipe connector which is easy to use and structurally reliable so as to minimize the chance of the pipe being accidentally detached from the quick pipe connector.

### Description of Related Arts

Chinese utility model patent CN208886210U disclosed a rapid connecting mechanism for pipes. The rapid connecting mechanism comprises a main body having a connecting hole for engaging with a pipe. The rapid connecting mechanism further comprises a connector ring having a plurality of engaging teeth inclinedly and movably extending towards the connecting hole. The rapid connecting mechanism further comprises an annular actuation member coupling to the connecting ring, and a securing tube member coupling to the annular actuation member and the main body. The annular actuation member may be moved toward the connecting hole for selectively applying an urging force toward the connecting ring so as to push the engaging teeth slightly away from the pipe for releasing the pipe from the rapid connecting mechanism. The securing tube member is arranged to couple with the main body and the annular actuation member, and comprises a pressing ring so that the connector ring is sandwiched and secured between the pressing ring and the annular actuation member.

A major problem of the above-mentioned rapid connecting mechanism is that when the pipe is subject to high pressure, such as when high-pressure fluid is passing through the pipe, the engaging teeth may accidentally be pushed away from the annular actuation member so that the engaging teeth fail to securely and tightly grasp against the pipe. This makes the pipe detach from the main body of the rapid connecting mechanism.

As a result, there is a need to provide a quick pipe connector which is easy to use and structurally reliable so as to minimize the chance of the pipe being accidentally detached from the quick pipe connector.

### Summary of the Present Invention

Certain variations of the present invention provide a quick pipe connector which is easy to use and structurally reliable so as to minimize the chance of the pipe being accidentally detached from the quick pipe connector.

Certain variations of the present invention provide a quick pipe connector comprising a coupling sleeve which is capable of reinforcing a plurality of catching claws so as to prevent the catching claws from accidentally deformed by high pressure developed by the fluid flowing through a pipe coupling to the quick pipe connector.

In one aspect of the present invention, it provides a quick pipe connector for connecting to a pipe, comprising:
a connector body having a main portion, a connecting portion extending from the main portion, and a through passage extending in the main portion and the connecting portion, the connecting portion having a diameter larger than that of the main portion so as to form a first shoulder at an intersection between the connecting portion and the main portion in the through passage, the connecting body further having an opening forming at the connecting portion and communicating with the through passage;
an inner sealing ring positioned in the through passage of the connector body and retained in position by the first shoulder;
an outer sealing ring;
a biasing ring sandwiched between the inner sealing ring and the outer sealing ring;
a securing ring attached to the connecting portion of the connector body in such a manner that the securing ring is arranged to bias against the outer sealing ring;
an engaging member which is arranged to bias against the securing ring and comprises a plurality of catching claws; and
a coupling sleeve comprising a main sleeve member having a through hole communicating with the through passage of the connector body, and an extension sleeve extending from the main sleeve member to engage with the connecting portion of the connector body, in such a manner that when the pipe is inserted in the connector body, the inner sealing ring, the outer sealing ring, the biasing ring, the securing ring and the engaging member are securely biased and retained between the connector body and the main sleeve member, the catching claws of the engaging member are arranged to allow the pipe to pass through the engaging member and subsequently bias against an external surface of the pipe so as to securely connect the pipe to the connector body.

This summary presented above is provided merely to introduce certain concepts and not to identify any key or essential features of the claimed subject matter.

### BRIEF DESCRIPTION OF THE DRAWINGS

FIG. 1A is a sectional side view of a quick pipe connector according to a preferred embodiment of the present invention.

FIG. 1B is a partially enlarged view of FIG. 1A.

FIG. 2 is an exploded side view of the quick pipe connector according to the preferred embodiment of the present invention.

FIG. 3 is an exploded side view of the quick pipe connector according to the alternative mode of the preferred embodiment of the present invention.

FIG. 4 is a sectional side view of a quick pipe connector according to an alternative mode of the preferred embodiment of the present invention.

FIG. 5 is another exploded side view of the quick pipe connector according to the alternative mode of the preferred embodiment of the present invention.

### Detailed Descriptions of the Present Invention

The following detailed description of the preferred embodiment is the preferred mode of carrying out the invention. The description is not to be taken in any limiting sense. It is presented for the purpose of illustrating the general principles of the present invention.

In the following descriptions, it should also be appreciated that the terms “arrange” and “set” in the following description refer to the connecting relationship in the accompanying drawings for easy understanding of the present invention. For example, the “arrange” and “set” may refer to one element directly or indirectly set or arrange on another element. Therefore, the above terms should not be an actual connection limitation of the elements of the present invention.

It should also be appreciated that the terms “center”, “length”, “width”, “thickness”, “top”, “bottom”, “front”, “rear”, “left”, “right”, “vertical ”, “horizontal”, “upper”, “lower”, “interior”, and “exterior” in the following description refer to the orientation or positioning relationship in the accompanying drawings for easy understanding of the present invention without limiting the actual location or orientation of the present invention. Therefore, the above terms should not be an actual location limitation of the elements of the present invention.

Moreover, it should be appreciated that the terms “”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “install”, “connect”, “couple”, and “mount” in the following description refer to the connecting relationship in the accompanying drawings for easy understanding of the present invention. For example, the connection may refer to permanent connection or detachable connection. Therefore, the above terms should not be an actual connection limitation of the elements of the present invention.

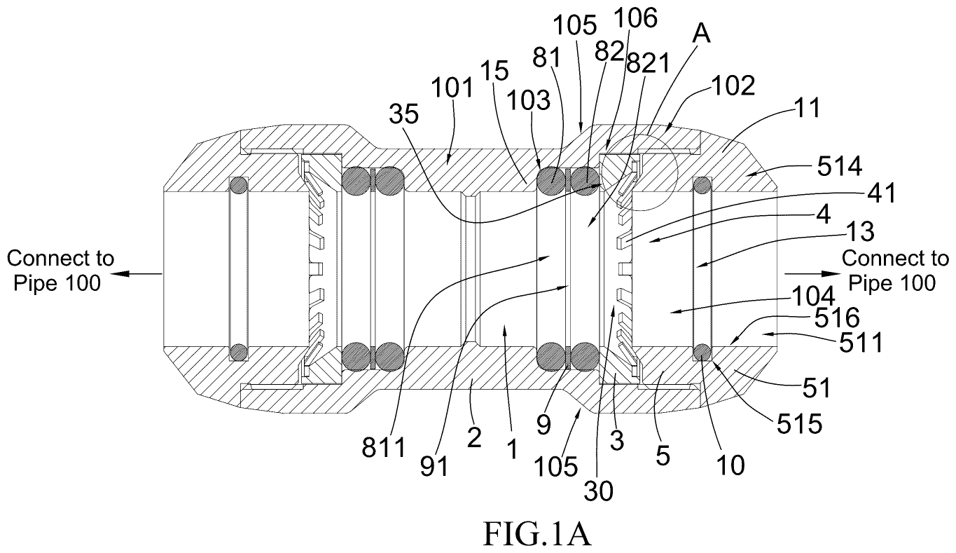

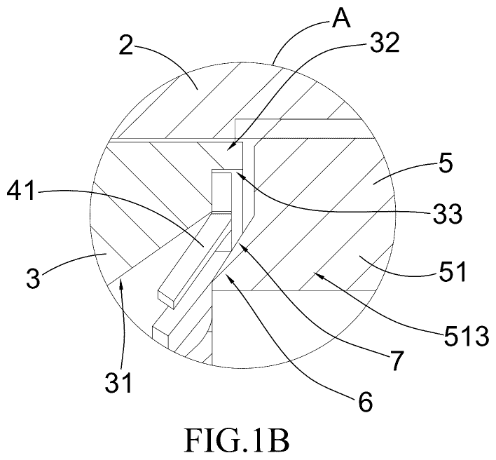

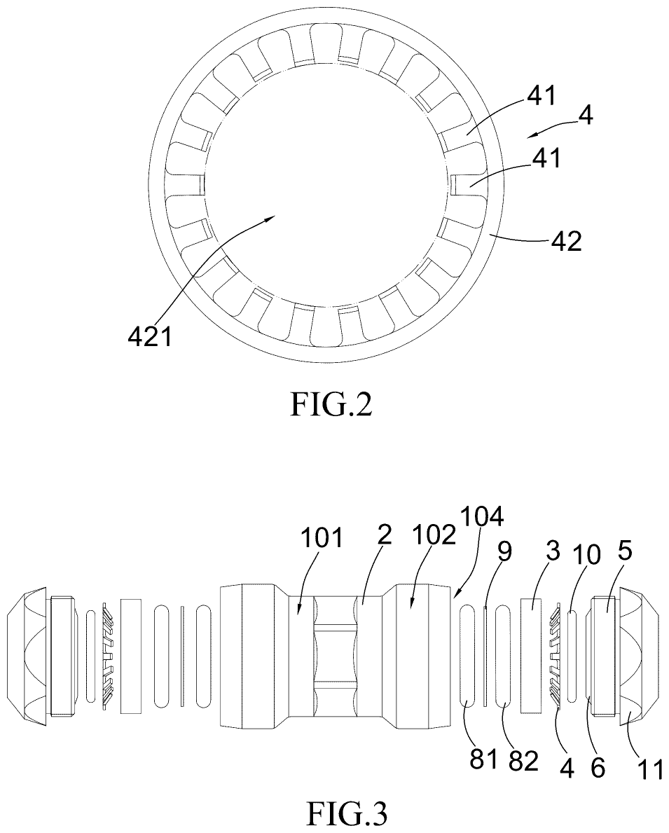

Referring to FIG. 1A, FIG. 1B, FIG. 2 to FIG. 3 of the drawings, a quick pipe connector according to a preferred embodiment of the present invention is illustrated. The quick pipe connector may be connected to at least two pipes 100, such as two water pipes. The purpose of the quick pipe connector is to allow convenient and secure connections between at least two pipes 100 so as to allow fluid such as water to flow from one pipe 100 to the other through the quick pipe connector of the present invention. Broadly, the quick pipe connector may comprise a connector body 2, an inner sealing ring 81, an outer sealing ring 82, a biasing ring 9, a securing ring 3, an engaging member 4 and a coupling sleeve 5.

The connector body 2 may have a main portion 101, a connecting portion 102 extending from the main portion 101, and a through passage 1 extending in the main portion 101 and the connecting portion 102. The connecting portion 102 may have a diameter larger than that of the main portion 101 so as to form a first shoulder 103 at an intersection between the connecting portion 102 and the main portion 101 in the through passage 1. The connector body 2 may further have an opening 104 forming at the connecting portion 102 and communicating with the through passage 1.

The inner sealing ring 81 may be positioned in the through passage 1 of the connector body 2 and retained in position by the first shoulder 103.

The biasing ring 9 may be sandwiched between the inner sealing ring 8 and the outer sealing ring 82.

The securing ring 3 may be attached to the connecting portion 102 of the connector body 2 in the through passage 1 in such a manner that the securing ring 3 may be arranged to bias against the outer sealing ring 82.

The engaging member 4 may be arranged to bias against the securing ring 3 and may comprise a plurality of catching claws 41.

The coupling sleeve 5 may comprise a main sleeve member 51 having a through hole 511 communicating with the through passage 1 of the connector body 2. The coupling sleeve 5 may be arranged to engage with the connecting portion 102 of the connector body 2, in such a manner that when the pipe 100 is inserted in the connector body 2, the inner sealing ring 81, the outer sealing ring 82, the biasing ring 9, the securing ring 3 and the engaging member 4 may be securely biased and retained between the connector body 2 and the coupling sleeve 5. The catching claws 41 of the engaging member 4 may be arranged to allow the pipe 100 to pass through the engaging member 4 and subsequently bias against an external surface of the pipe 100 so as to securely connect the pipe 100 to the connector body 2.

According to the preferred embodiment of the present invention, the connector body 2 may be configured from rigid, erosive-resistant and strong material such as stainless steel or reinforced composite material. The connector body 2 may have a plurality of openings 104 formed thereon, wherein each of the openings 104 may be connected to a pipe 100, such as a water pipe or a gas pipe. The openings 104 may also communicate with the through passage 1, so that the connector body 2 as a whole may be configured to form a hollow structure.

The quick pipe connector of the present invention provides a rapid and convenient mechanism by which the pipe 100 may be connected thereto and detached therefrom, so that when two or more pipes 100 are connected to the quick pipe connector of the present invention, fluid such as water flowing from one of the connected pipes 100 may flow into the other connected pipes 100 through the quick pipe connector of the present invention. As shown in FIG. 1A to FIG. 1B of the drawings, the connector body 1 may have two openings 104 formed on the left side and the right side of the connector body 2 respectively.

For the sake of clarity, note that the connecting mechanism at each of the openings 104 is structurally identical. The description presented herein is applicable to all openings 104. For example, the descriptions presented above are applicable to one of the openings 104. When the connector body 2 has two openings for connecting two pipes 100, the connection between each pipe 100 and the corresponding opening 104 of the connector body 2 will be identical and will not be repeated throughout this description.

As shown in FIG. 1A to FIG. 1B of the drawings, the connecting portion 102 may have a cross-sectional diameter larger than that of the main portion 101 so as to constitute an enlarged part with respect to the main portion 101. The connecting portion 102 may radially and outwardly extend from the main portion 101 to be connected to the corresponding pipe 100. The intersection between the connecting portion 102 and the main portion 101 may form a first shoulder 103 in the through passage 1. This first shoulder 103 may be a sidewall in the through passage 1 having a sharp turning or cornering due to a sudden change in diameter. Therefore, when viewed from an exterior of the connector body 2, the connecting portion 102 may form a step 105 with respect to the main portion 101.

The inner sealing ring 81 may be provided in the through passage 1 at a position at the first shoulder 103. In other words, the first shoulder 103 may form a space in the through passage 1 for accommodating the inner sealing ring 81. The inner sealing ring 81 may be configured as having an annular shape and may have an inner central opening 811 communicating with the corresponding opening 104 of the connector body 1. Referring to FIG. 1A to FIG. 1B of the drawings, the inner sealing ring 81 may bias against the first shoulder 103 so that when an inward pushing force (in the direction toward the main portion 101 of the connector body 2) is applied to the inner sealing ring 81, the inner sealing ring 81 may be securely held in position by the first shoulder 103. A diameter of the inner sealing ring 81 may correspond to the cross-sectional diameter of the first shoulder 103 when viewed from the side of the connector body 2.

On the other hand, the outer sealing ring 82 may be provided in the through passage 1 at a position near the first shoulder 103. More specifically, the outer sealing ring 82 may bias against the securing ring 3. The outer sealing ring 82 may also be configured as having an annular shape and may have an outer central opening 821 communicating with the corresponding opening 104 of the connector body 2.

The inner sealing ring 81 and the outer sealing ring 82 may be arranged in a side-by-side manner in which the biasing ring 9 may be sandwiched between the inner sealing ring 81 and the outer sealing ring 82, as shown in FIG. 1A to FIG. 1B of the drawings. Thus, the biasing ring 9 may also be configured as having an annular shape and may have an intermediate central opening 91 communicating with the corresponding opening 104 of the connector body 2. In this preferred embodiment of the present invention, the inner central opening 811, the outer central opening 821, and the intermediate central opening 91 may have substantially identical diameter and may align with each other along a longitudinal direction of the connector body 2. Thus, the pipe 100 may pass through the through passage 1 and the inner central opening 811, the outer central opening 821, and the intermediate central opening 91.

It is worth mentioning that the use of the inner sealing ring 81, the outer sealing ring 82 and the biasing ring 9 is to stabilize and retain the structural shape of these components to the maximum extent when the pipe 100 is inserted from the opening 104 of the connector body 2. When the pipe 100 is being inserted through the opening 104, each of the inner sealing ring 81, the outer sealing ring 82 and the biasing ring 9 may maximally resist the torsion caused by the insertion of the pipe 100. Thus, the inner sealing ring 81, the outer sealing ring 82 and the biasing ring 9 and their arrangement in the connector body 2 may prevent each one of these elements to be excessively distorted as the pipe 100 is being inserted in the connector body 2.

Referring to FIG. 1A to FIG. 1B of the drawings, the securing ring 3 may be secured in the connecting portion 102 of the connector body 2. The securing ring 3 may be attached on the connecting portion 102 at an outer side of the outer sealing ring 82 and may be arranged to bias against the outer sealing ring 82. In this preferred embodiment of the present invention, at least some portions of the inner sealing ring 81, the outer sealing ring 82 and the biasing ring 9 may be sandwiched between the first shoulder 103 and the securing ring 3.

Moreover, the securing ring 3 may be configured as having an annular structure and may have a securing opening 30. This securing opening 30 may communicate with the inner central opening 811, the outer central opening 821, the intermediate central opening 91, and the through passage 1 of the connector body 2.

As shown in FIG. 1A to FIG. 1B of the drawings, the securing ring 3 may be securely coupled and sandwiched between the outer sealing ring 82 and the coupling sleeve 5. A diameter of the securing opening 30 of the securing ring 3 may gradually increase from the outer sealing ring 82 toward the coupling sleeve 5. Accordingly, the peripheral wall 31 of the securing opening 30 may be inclined when viewed from the side to form the gradually varying diameter of the securing opening 30, as illustrated in FIG. 1A to FIG. 1B of the drawings.

Moreover, the securing ring 3 may further define a securing platform 33 peripherally formed on an outer side portion 32 of the securing ring 3 for accommodating the engaging member 4. The securing platform 33 may be formed by having an indention formed on the outer side portion 32 of the securing platform 33, wherein the engaging member 4 may be fittedly supported in the securing platform 33 of the securing ring 3. Note that an “outer side” of the securing ring 3 means the side which is near the coupling sleeve 5.

Moreover, the connecting portion 102 of the connector body 2 may further define a second shoulder 106 formed by a difference in diameter of the connecting portion 102, wherein an inner side 35 of the securing ring 3 may bias against the second shoulder 106 and the outer sealing ring 82. Note that an “inner side 35” of the securing ring 3 means the side which is near the outer sealing ring 82.

Referring to FIG. 1A, FIG. 1B and FIG. 2 of the drawings, the engaging member 4 may comprise an annular frame member 42 and a plurality of catching claws 41 extending from the annular frame member 42 toward the main portion 101 of the connector body 2. The annular frame member 42 may have an annular opening 421 communicating with the securing opening 30, the inner central opening 811, the outer central opening 821, the intermediate central opening 91, and the through passage 1 of the connector body 2. The annular frame member 42 may be supported on the securing platform 33, while the catching claws 41 may spacedly extend toward the main portion 101 of the connector body 2.

Each of the catching claws 41 may be configured to be elastic and slightly deformable and so may be arranged to bias against (i.e. “catch”) the pipe 100 extending through the through passage 1. Each of the catching claws 41 may be configured such that when the pipe 100 is pushed toward the connector body 1, the catching claws 41 may slightly deform to allow the pipe 100 to pass through the annular frame member 42 and bias against an external surface of the pipe 100. However, once the pipe 100 passes through the catching claws 41 and the annular frame member 42, the catching claws 41 may exert a biasing force to the pipe 100 so as to prevent the pipe from being pulled out from the connector body 1.

The catching claws 41 may have two or more different lengths for more effectively catching the external surface of the pipe 100. In this preferred embodiment of the present invention, the catching claws 41 may have two different lengths (i.e. a shorter length and a longer length), wherein a length of each adjacent catching claws 41 is different. In other words, a catching claw 41 of a longer length is arranged to be adjacent to a catching claw 41 of a shorter length. Thus, the catching claws 41 of two different lengths are alternatively arranged along the circumference of the annular frame member 42. The engaging member 4 may have nine catching claws 41 having a shorter length and nine catching claws having a longer length. Each of the shorter catching claws 41 has identical length, and each of the longer catching claws 41 also has identical length.

On the other hand, the coupling sleeve 5 may be connected to the connecting portion 102 of the connector body 2 and bias against the securing ring 3 and the engaging member 4. Referring to FIG. 1A, FIG. 1B and FIG. 2 of the drawings, the main sleeve member 51 of the coupling sleeve 5 may bias against the securing ring 3 which in turn may bias against the shoulder 103 of the connector body 2.

Moreover, the coupling sleeve 5 may further have a peripheral protrusion 6 extending from the main sleeve member 51 for reinforcing the catching claws 41 of the engaging member 4. In particular, the peripheral protrusion 6 may extend toward the catching claws 41 so as to physically reinforce and restrict the movement of the catching claws 41 for preventing the catching claws 41 from excessively pushed away from the pipe 100. It is worth mentioning that peripheral protrusion 6 may radially and integrally extend from the main sleeve member 51 to form a reinforcing platform 7 on the peripheral protrusion 6. The reinforcing platform 7 may be provided in a position corresponding to an extension path of the catching claws 41. As such, as the pipe 100 is subject to high pressure, such as when high pressure fluid is passing through the pipe 100, the catching claws 41 may be prevented from undesirably bending away from the pipe 100. In other words, the catching claws 41 may be retained to have secure engagement with the pipe 100 so as to prevent the pipe 100 from loosening from the quick pipe connector of the present invention.

It is worth mentioning that the peripheral protrusion 6 and the main sleeve member 51 may form an integral body while the peripheral protrusion 6 may have a substantially smooth and flat surface for reinforcing the catching claws 41. Since the flat surface (i.e. no shape edges) of the peripheral protrusion 6 may ensure maximum contact surface area between the relevant catching claws 41 and the peripheral protrusion 6, and prevent damage to the catching claws 41.

The through hole 511 of the coupling sleeve 5 may overlap with the securing opening 30 of the securing ring 3 so that the pipe 100 may be able to be inserted into the connector body 2 through the through hole 511. The coupling sleeve 5 may extend from the securing ring 3. The main sleeve member 51 may be configured to have a coupling end portion 514 and an extension portion 513 extending between the coupling end portion 514 and the securing ring 3. An external diameter of the extension portion 513 is smaller than that of the coupling end portion 514. As shown in FIG. 1A to FIG. 1B of the drawings, the coupling end portion 514 of the main sleeve member 51 may bias against the connecting portion 102 of the connector body 2 when the pipe 100 is inserted thereto. The coupling end portion 514 and the extension portion 513 may form an integral structure. The main sleeve member 51 may be rotatably connected to the connector body 2.

Moreover, the main sleeve member 51 of the coupling sleeve 5 may further have a coupling slot 515 peripherally formed on an inner surface 516 of the through hole 511. The coupling slot 515 may be formed on either one of the coupling end portion 514 or the extension portion 513, or partially on the coupling end portion 514 and the extension portion 513. The quick pipe connector may further comprise a stabilizing ring 10 secured in the coupling slot 515 and arranged to engage with the pipe 100 when the water pipe 100 is inserted in the connector body 2. The stabilizing ring 10 may be configured from deformable and elastic material such as silicon rubber so as to provide make the pipe 100 to be more stable in the connector body 2 when high pressure fluid is passing through the pipe 100. The stabilizing ring 10 may fill the gap which may be formed between an external surface of the pipe 100 and the inner surface 516 of the main sleeve member 511. Accordingly, the stabilizing ring 10 may have a through insertion hole 13 for allowing the pipe 100 to pass through.

When the pipe 100 is inserted in the connector body 2, the pipe 100 may be arranged to pass through the through hole 511 of the main sleeve member 51, the through insertion hole 13 of the stabilizing ring 10, the annular opening 421 of the annular frame member 42, the through opening 30 of the securing ring 3, the outer central opening 821 of the outer sealing ring 821, the intermediate central opening 91 of the biasing ring 9, and the inner central opening 811 of the inner sealing ring 81.

The operation of the present invention may be described as follows: a user may manually insert the pipe 100 into the connector body 2 through the through hole 511 of the main sleeve member 51. Since the inner sealing ring 81, the outer sealing ring 82, the securing ring 3 and the coupling sleeve 5 are fittedly coupled together in the manner described above, and the pipe 100 is securely retained by the catching claws 41, the pipe 100 may be securely connected to the quick pipe connector of the present invention with minimal chance of leaking. Since the catching claws 41 are securely reinforced by the reinforcing platform 7, the pipe 100 may be securely retained by the catching claws 41, even when the pipe 100 is subject to high pressure. The catching claws 41 may be prevented from excessively deformed or being damaged.

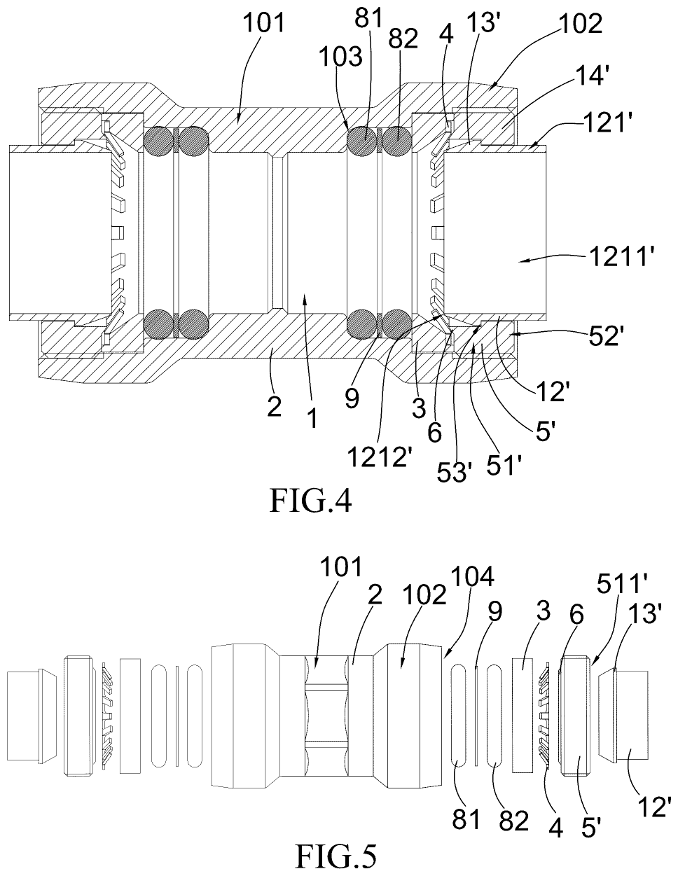

Referring to FIG. 4 to FIG. 5 of the drawings, an alternative mode of the quick pipe connector according to the preferred embodiment of the present invention is illustrated. The alternative mode is similar to the preferred embodiment described above, except the coupling sleeve 5′, and that the quick pipe connector may further comprise a pipe detachment tool 12′.

According to the alternative mode of the preferred embodiment, the coupling sleeve 5′ may have a generally annular structure having a through hole 511′ communicating with the annular opening 421 of the annular frame member 42. Moreover, the coupling sleeve 5′ may have an inner contracted portion 51′ and an outer enlarged portion 52′ extending from the inner contracted portion 51′. A diameter of the outer enlarged portion 52′ may be larger than that of the inner contracted portion 51′ to form a coupling shoulder 13′ between the inner contracted portion 51′ and the outer enlarged portion 52′, wherein the through hole 511′ may extend through the contracted portion 51′ and the enlarged portion 52′, as shown in FIG. 4 of the drawings.

On the other hand, the quick pipe connector of the present invention may further comprise a pipe detachment tool 12′ selectively attached to the connector body 2 for facilitating easy detachment of the pipe 100 from the connector body 2. More specifically, the pipe detachment tool 12′ may be configured as having a tubular mechanism and may comprise an insertion tube 121′ and a ridge 14′ radially and outwardly extending from the insertion tube 121′. The insertion tube 121′ may have an inner through hole 1211′ having a diameter larger than that of the pipe 100 so that the pipe 100 may be inserted in the insertion tube 121′.

As shown in FIG. 4 of the drawings, the ridge 14′ may outwardly and inclinedly extend from an inner side edge 1212′ of the insertion tube 121′ to engage with the coupling shoulder 13′ of the coupling sleeve 5′ in such a manner that the coupling sleeve 5′ may restrict an outward movement of the insertion tube 121′. However, the insertion tube 121′ may be able to be inwardly pushed to loosen the catching claws 41.

Thus, the insertion tube 121′ may be arranged to be inserted in the connector body 2 in such a manner that the insertion tube 121′ may be inserted between the pipe 100 and the catching claws 41 so that when the insertion tube 121′ is inserted toward the connector body 2, the catching claws 41 may be pushed outwardly for releasing the biasing force against the pipe 100. Thus, the pipe 100 may be conveniently released from the connector body 2.

In this alternative mode, the coupling sleeve 5′ may also have the peripheral protrusion 6 which is identical to that described in the preferred embodiment above. Thus, the peripheral protrusion 6 may radially and integrally extend from the main sleeve member 51 to form a reinforcing platform 7 on the peripheral protrusion 6. The reinforcing platform 7 may be provided in a position corresponding to an extension path of the catching claws 41.

The present invention, while illustrated and described in terms of a preferred embodiment and several alternatives, is not limited to the particular description contained in this specification. Additional alternative or equivalent components could also be used to practice the present invention.

What is claimed is:

1. A quick pipe connector for connecting to a pipe, comprising:
a connector body having a main portion, a connecting portion extending from the main portion, and a through passage extending in the main portion and the connecting portion, the connecting portion having a diameter larger than that of the main portion so as to form a first shoulder at an intersection between the connecting portion and the main portion in the through passage, the connecting body further having an opening forming at the connecting portion and communicating with the through passage;
an inner sealing ring positioned in the through passage of the connector body and retained in position by the first shoulder;
an outer sealing ring;
a biasing ring sandwiched between the inner sealing ring and the outer sealing ring;
a securing ring attached to the connecting portion of the connector body in such a manner that the securing ring is arranged to bias against the outer sealing ring;
an engaging member which is arranged to bias against the securing ring and comprises a plurality of catching claws; and
a coupling sleeve comprising a main sleeve member having a through hole communicating with the through passage of the connector body, and an extension sleeve extending from the main sleeve member to engage with the connecting portion of the connector body, in such a manner that when the pipe is inserted in the connector body, the inner sealing ring, the outer sealing ring, the biasing ring, the securing ring and the engaging member are securely biased and retained between the connector body and the main sleeve member, the catching claws of the engaging member are arranged to allow the pipe to pass through the engaging member and subsequently bias against an external surface of the pipe so as to securely connect the pipe to the connector body.

2. The quick pipe connector, as recited in claim 1, wherein the connecting portion has a cross-sectional diameter larger than that of the main portion so as to constitute an enlarged part with respect to the main portion, wherein the intersection between the connecting portion and the main portion forms a first shoulder in the through passage, the inner sealing ring being provided in the through passage at a position at the first shoulder.

3. The quick pipe connector, as recited in claim 2, wherein the inner sealing ring is configured as having an annular shape and has an inner central opening communicating with the corresponding opening of the connector body, the inner sealing ring being arranged to bias against the first shoulder so that when an inward pushing force is applied to the inner sealing ring, the inner sealing ring is securely held in position by the first shoulder.

4. The quick pipe connector, as recited in claim 3, wherein the outer sealing ring is configured as having an annular shape and has an outer central opening communicating with the opening of the connector body, the outer sealing ring being provided in the through passage and arranged to bias against the securing ring.

5. The quick pipe connector, as recited in claim 4, wherein the inner sealing ring and the outer sealing ring are arranged in a side-by-side manner in which the biasing ring is sandwiched between the inner sealing ring and the outer sealing ring, the biasing ring being configured as having an annular shape and has an intermediate central opening communicating with the inner central opening and the outer central opening.

6. The quick pipe connector, as recited in claim 1, wherein the securing ring is configured as having an annular structure and has a securing opening communicating with the through passage of the connector body, the securing ring being securely coupled and sandwiched between the outer sealing ring and the coupling sleeve, wherein a diameter of the securing opening of the securing ring gradually increases from the outer sealing ring toward the coupling sleeve.

7. The quick pipe connector, as recited in claim 5, wherein the securing ring is configured as having an annular structure and has a securing opening communicating with the through passage of the connector body, the securing ring being securely coupled and sandwiched between the outer sealing ring and the coupling sleeve, wherein a diameter of the securing opening of the securing ring gradually increases from the outer sealing ring toward the coupling sleeve.

8. The quick pipe connector, as recited in claim 6, wherein the securing ring further defines a securing platform peripherally formed on an outer side portion of the securing ring for accommodating the engaging member, the securing platform being formed by an indention on the outer side portion of the securing platform, wherein the engaging member is fittedly supported in the securing platform of the securing ring.

9. The quick pipe connector, as recited in claim 7, wherein the securing ring further defines a securing platform peripherally formed on an outer side portion of the securing ring for accommodating the engaging member, the securing platform being formed by an indention on the outer side portion of the securing platform, wherein the engaging member is fittedly supported in the securing platform of the securing ring.

10. The quick pipe connector, as recited in claim 8, wherein the engaging member further comprises an annular frame member, wherein the plurality of catching claws extends from the annular frame member toward the main portion of the connector body, the annular frame member having an annular opening communicating with the securing opening, the inner central opening, the outer central opening, the intermediate central opening, and the through passage of the connector body, the annular frame member being supported on the securing platform, while the catching claws spacedly extending toward the main portion of the connector body.

11. The quick pipe connector, as recited in claim 9, wherein the engaging member further comprises an annular frame member, wherein the plurality of catching claws extends from the annular frame member toward the main portion of the connector body, the annular frame member having an annular opening communicating with the securing opening, the inner central opening, the outer central opening, the intermediate central opening, and the through passage of the connector body, the annular frame member being supported on the securing platform, while the catching claws spacedly extending toward the main portion of the connector body.

12. The quick pipe connector, as recited in claim 10, wherein the coupling sleeve further has a peripheral protrusion integrally and radially extending from the main sleeve member to form a reinforcing platform for reinforcing the catching claws of the engaging member, the peripheral protrusion extending toward the catching claws so as to reinforce and restrict the movement of the catching claws for preventing the catching claws from excessively pushed away from the pipe, the reinforcing platform being positioned corresponding to an extension path of the catching claws, the reinforcing platform forming a flat and smooth surface for providing maximum contact surface area between the corresponding catching claws and the peripheral protrusion.

13. The quick pipe connector, as recited in claim 11, wherein the coupling sleeve further has a peripheral protrusion integrally and radially extending from the main sleeve member to form a reinforcing platform for reinforcing the catching claws of the engaging member, the peripheral protrusion extending toward the catching claws so as to reinforce and restrict the movement of the catching claws for preventing the catching claws from excessively pushed away from the pipe, the reinforcing platform being positioned corresponding to an extension path of the catching claws, the reinforcing platform forming a flat and smooth surface for providing maximum contact surface area between the corresponding catching claws and the peripheral protrusion.

14. The quick pipe connector, as recited in claim 12, further comprising a stabilizing ring, wherein the main sleeve member of the coupling sleeve further has a coupling slot peripherally formed on an inner boundary surface of the through hole of the main sleeve member, wherein the stabilizing ring being secured in the coupling slot and arranged to engage with the pipe when the pipe is inserted in the connector body.

15. The quick pipe connector, as recited in claim 13, further comprising a stabilizing ring, wherein the main sleeve member of the coupling sleeve further has a coupling slot peripherally formed on an inner boundary surface of the through hole of the main sleeve member, wherein the stabilizing ring being secured in the coupling slot and arranged to engage with the pipe when the pipe is inserted in the connector body.

16. The quick pipe connector, as recited in claim 10, wherein the coupling sleeve has an inner contracted portion and an outer enlarged portion extending from the inner contracted portion, a diameter of the outer enlarged portion being larger than that of the inner contracted portion to form a coupling shoulder between the inner contracted portion and the outer enlarged portion, wherein the through hole extend through the contracted portion and the enlarged portion.

17. The quick pipe connector, as recited in claim 16, further comprising a pipe detachment tool which is movably coupled to the coupling sleeve, and comprises an insertion tube, and a ridge radially and outwardly extending from the insertion tube, the insertion tube having an inner through hole which has a diameter larger than that of the pipe, the ridge outwardly and inclinedly extending from an inner side edge of the insertion tube to engage with the coupling shoulder of the coupling sleeve in such a manner that the coupling sleeve is arranged to restrict an outward movement of the insertion tube, the insertion tube being arranged to be inwardly pushed to loosen the catching claws for releasing the biasing force against the pipe.
